(19) United States
(12) Patent Application Publication
(10) Pub. No.: US 2025/0267125 A1
(43) Pub. Date: Aug. 21, 2025

(54) EFFICIENT, RESOURCE-AWARE SECURITY OPERATIONS IN SOFTWARE-DEFINED NETWORKS

(71) Applicant: Nokia Solutions and Networks Oy, Espoo (FI)

(72) Inventors: Jithendrian S, Bangalore (IN); Shailesh Prabhu, Manipal (IN)

(73) Assignee: Nokia Solutions and Networks Oy, Espoo (FI)

(21) Appl. No.: 18/581,844

(22) Filed: Feb. 20, 2024

(51) Int. Cl. H04L 9/40

(52) U.S. Cl. CPC H04L 63/0245

(57) ABSTRACT

In a software-defined network (SDN), user packets have a security header that identifies a set of security operations to be performed by the SDN on user data packets, where different network service gateways (NSGs) in a cluster of NSGs of the SDN are enabled to perform different subsets of the security operations. The bits of the security header indicate which security operations still need to be performed and which security operations do not need to be performed either because they have already been performed or are not selected to be performed. Each NSG that receives a user data packet reads the security header to determine which if there are any needed security operations that that NSG is enabled to perform. If so, then the NSG performs those needed security operations and updates the security header appropriately to prevent those same security operations from being repeated by a subsequent NSG.

### BACKGROUND

### Field of the Disclosure

The present disclosure relates to software-defined networks and, more specifically but not exclusively, to techniques for performing security operations in software-defined networks.

### Description of the Related Art

This section introduces aspects that may help facilitate a better understanding of the disclosure. Accordingly, the statements of this section are to be read in this light and are not to be understood as admissions about what is prior art or what is not prior art.

Security has become the core part of digital infrastructure in today's world. With increasing demands for secured digital infrastructure, security in these networks has been one of the prime factors of consideration. In large SDN (software-defined network)/SDWAN (software-defined wide area network) enterprise networks where several thousands of end-point network service gateways (NSGs) are deployed across the network, depending on security requirements, a set of security operations are often enabled in these NSGs to protect both access and the core network. The security operations may include threat prevention, web filtering, intrusion detection/prevention, internet key exchange (IKE), deep packet inspection, etc.

### SUMMARY

Performing a security operation is a resource-demanding operation, which may lead to blocking out other important core features. Hence, there is a need for systems and methods that can selectively perform a security operation at an NSG-cluster level based on resource optimization and make sure the same packet does not undergo redundant security operations in its network gateway cluster.

With growing networks and the need for security in such networks, it is important to optimally perform security operations and avoid redundant security checks in networks. At least some embodiments of the present disclosure involve techniques for selectively performing security checks considering resource availability in network service gateways. At least some embodiments introduce into the user packet format a security header that defines the list of security operations already performed and/or to be performed. These techniques can be used to efficiently perform security operations in SDN/SDWAN networks or similar kinds of infrastructure such as SASE (secure access service edge) networks. As used herein, the term “software-defined network” or SDN, for short, refers to all of these different kinds of networks.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of a software-defined network (SDN) according to certain embodiments of the present disclosure;

FIG. 2 is a slightly more detailed view of a network service gateway (NSG) of FIG. 1;

FIG. 3 is a representation of the format for the user data packets in the SDN of FIG. 1;

FIG. 4 is a representation of an example route lookup table for the SDN of FIG. 1;

FIG. 5 is a flow diagram of the user-packet processing performed by an NSG of the SDN of FIG. 1 as it relates to the performance of security operations; and

FIG. 6 is a simplified hardware block diagram of an example node that can be used to implement any of the nodes of FIG. 1, such as the network management system and each NSG, as well as each user equipment and the external network that communicates via the SDN of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

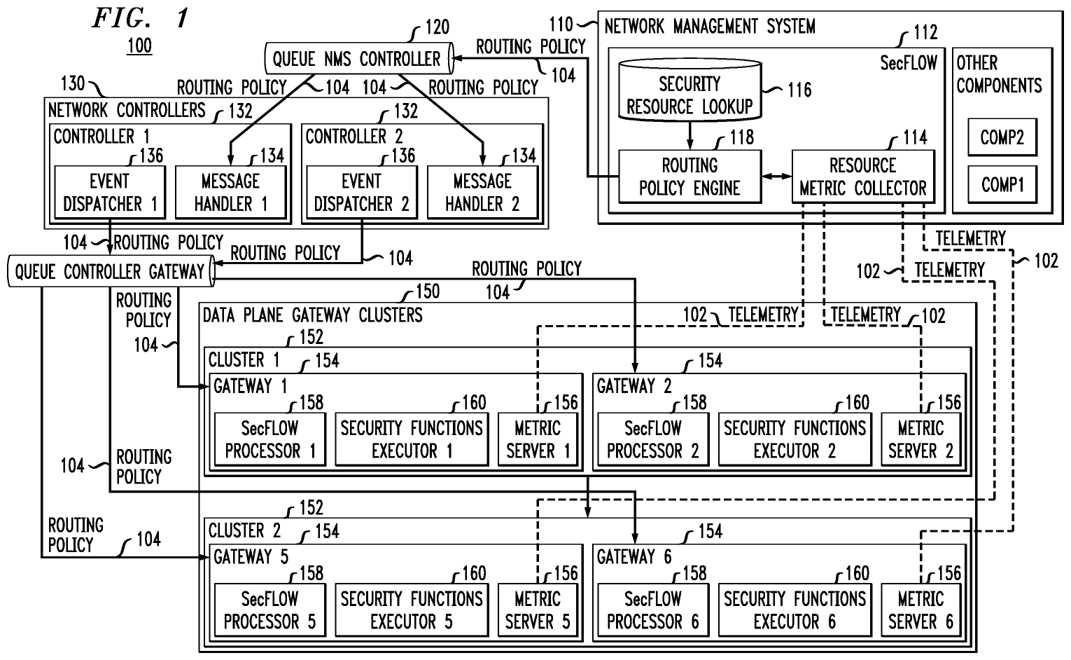

FIG. 1 is a block diagram of a software-defined network (SDN) 100 according to certain embodiments of the present disclosure. As shown in FIG. 1, the SDN 100 has a network management system (NMS) 110 that handles (i.e., controls and/or performs) the application-layer operations of the SDN 100, a set 130 of one or more network controllers 132 that handle the control-layer operations of the SDN 100, and a set 150 of one or more data-plane gateway clusters 152 that handle the data-layer operations of the SDN 100, where each cluster 152 has one or more logically related, network service gateways (NSGs) 154. Although FIG. 1 shows two network clusters 152, each with two NSGs 154, those skilled in the art will understand that SDN 100 may have any suitable number of network clusters 152, with each network cluster 152 independently having any suitable number of NSGs 154.

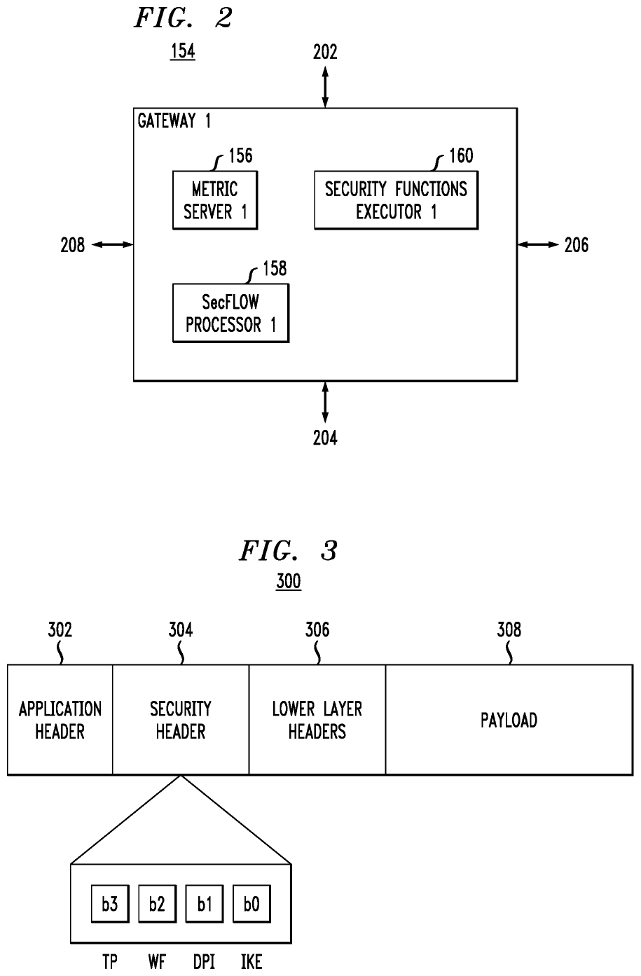

FIG. 2 is a slightly more detailed view of an NSG 154 of FIG. 1. As shown in FIG. 2, the NSG 154 has:
Control port 202 via which the network controllers 132 of FIG. 1 communicate with the NSG 154 to control the operations of the NSG 154;
Access port 204 via which user data packets flow between the NSG 154 and the user equipment (UE) (not shown in the figures) of the users of SDN 100;
Gateway port 206 via which user data packets flow between the NSG 154 and other NSGs 154 of the SDN 100; and
Network port 208 via which user data packets flow between the NSG 154 and an external network, such as the Internet.

In a typical operation, an upstream (i.e., from a UE to the external network) user (data) packet flows from the UE to a first NSG 154 via its access port 204. From there, the user packet may sequentially flow from the first NSG 154 through one or more subsequent NSGs 154 through their gateway ports 206 before flowing from the last of those subsequent NSGs 154 to the external network via the network port 208 of that last NSG. Analogously, a downstream (i.e., from the external network to a UE) user packet flows from the external network to a first NSG 154 via its network port 208. From there, the user packet may sequentially flow from the first NSG 154 through one or more subsequent NSGs 154 through their gateway ports 206 before flowing from the last of those subsequent NSGs 154 to a UE via the access port 204 of that last NSG. As each upstream and downstream user packet flows through the SDN 100, the set of NSG 154 through which the user packet passes will collectively perform a specified set of security operations for that user packet.

The SDN 100 of FIG. 1 conforms to an industry standard that identifies four specific security operations for user packets, any number of which may be performed by a conforming SDN. The standard defines the location of a four-bit security header as part of the packet format for conforming SDNs. Those skilled in the art will understand that other standards may define other sets of one or more security operations and a corresponding security header.

FIG. 3 is a representation of the format for the user packets 300 in the SDN 100 of FIG. 1 according to one possible implementation of the industry standard to which the SDN 100 conforms. As shown in FIG. 3, each packet 300 has an application header 302, followed by the four-bit security header 304, followed by one or more lower-layer headers 306, followed by the packet payload 308, where:
The first bit b0 of the security header 304 corresponds to an internet key exchange (IKE) security operation;
The second bit b1 of the security header 304 corresponds to a deep packet inspection (DPI) security operation;
The third bit b2 of the security header 304 corresponds to a web filtering (WF) security operation; and
The fourth bit b3 of the security header 304 corresponds to a threat prevention (TP) security operation.
   As described further below, in this implementation, a value of 0 for the security-header bit b0 in a packet 300 indicates that the IKE security operation has not yet been performed for that packet, while a value of 1 indicates that the IKE security operation has already been performed or is not to be performed for that packet, and likewise for the three other security-header bits b1, b2, and b3 and the three other security functions DPI, WF, and TP, respectively.

As suggested above, those skilled in the art will understand that, in general, a given industry standard may define a security header to have any suitable, fixed number of bits, where each of those one or more bits corresponds to different, specific security operation.

Referring again to FIG. 1, the NMS 110 has a security flow (SecFlow) module 112 that communicates, via an NMS queue controller (queueNMSController) 120, with message handler components 134 in the network controllers 132, which also have event dispatchers 136 that communicate, via a gateway queue controller (queueControllerGateway) 140, with the NSGs 154 in the gateway clusters 152.

The SecFlow module 112 is a resource management block that dynamically analyses resource metrics from the various network gateway clusters 152 and identifies the most-optimal NSGs 154 to perform specific security operations. The SecFlow module 112 includes the following sub-components:
Resource metrics collector (RMC) 114 collects and stores resource metrics from network gateway clusters 152 for analytics.
Security resource lookup table 116 stores information regarding the expected amount of resources required to perform each security operation. Each expected value can be based on the historical operations of the corresponding security operation running on various platforms.
Routing policy engine 118 collects the resources metrics for each NSG 154 from the RMC 114, accesses the security resource lookup table 116 for resources required for each security operations, fuses the information to generate an optimized Route Lookup Table (RLT), and shares the RLT with the NSGs 154.

Each NSG 154 has a metric server 156, which characterizes the operations of its NSG 154 and provides resource metrics for those NSG operations as telemetry 102 to a resource metric collector 114 in the SecFlow module 112 of the NMS 110. Examples of resource metrics include (without limitation) memory utilization and CPU (central processing unit) consumption. A routing policy engine (RPE) 118 in the SecFlow module 112 uses those gateway-based resource metrics to determine which NSGs 154 are best suited to perform which specific security operations. The RPE 118 stores these results as a route lookup table (RLT) in a security resource lookup (SRL) memory 116 in the SecFlow module 112.

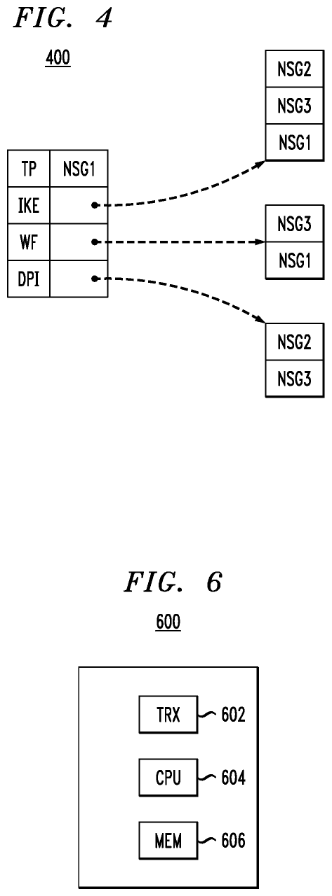

FIG. 4 is a representation of an example route lookup table (RLT) 400, where:
Security operation TP is best performed by a first subset NSG1 of NSGs 154;
Security operation IKE is best performed by a second subset NSG2 of NSGs 154, then a third subset NSG3 of NSGs 154, then the first gateway subset NSG1;
Security operation WF is best performed by the third gateway subset NSG3, then the first gateway subset NSG1; and
Security operation DPI is best performed by the second gateway subset NSG2, then the third gateway subset NSG3.
   Depending on the implementation, the ith gateway subset NSGi may correspond to a single NSG 154 or two or more different NSGs 154. The RLT 400 is a mapping that identifies which NSGs are enabled to perform which security operations. Those skilled in the art will understand that there are ways other than an RLT, such as RLT 400, to represent such a mapping.

For the two resource metrics of memory usage and CPU usage, if the amount of memory used by a particular security operation is not more than the memory available in an NSG and if the amount of CPU cycles used by that security operation is not more than the CPU cycles available in that NSG, then that NSG can perform that security operation as indicated in the RLT. Note that, in order for a particular NSG to be able to perform multiple security operations, that NSG must have enough memory and CPU capacity to handle all of those operations.

After determining the RLT 400, the management-plane routing policy engine 118 of FIG. 1 pushes a copy of the RLT 400 as a routing policy 104, through the queueNMS controller 120, the network controllers 132, and the queueControllerGateway 140, down to a SecFlow processor 158 in each NSG 154. Each NSG 154 uses the RLT 400 to identify which security operations can be performed by that NSG 154.

In addition to the RLT 400 of FIG. 4, the routing policy engine 118 also pushes down to each NSG 154 a copy of a so-called initial security header value, which is a four-bit value that identifies the security operations to be performed on each user packet 300 that flows through the SDN 100, where a bit value of 0 in the initial security header value indicates that the corresponding security operation is to be performed for each packet, while a bit value of 1 in the initial security header value indicates that the corresponding security operation is not to be performed for each packet. For example, referring again to FIG. 3, an initial security header value having a four-bit value (b3 b2 b1 b0) of (0 1 0 0) indicates that the security operations TP, DPI, and IKE are to be performed for each packet 300, but not the security operation WF. As described below, the first NSG 154 that receives a particular packet 300 will store the initial security header value into the packet's security header field 304. Any NSG 154 that subsequently receives that same packet 300 will process that packet based on the state of the existing value stored in the packet's security header field 304 without reference to or insertion of the initial security header value.

In some implementations, the SecFlow module 112 periodically (as configured by a network administrator) receives current resource metrics from the NSGs 154 to generate and distribute to the NSGs 154 an updated version of the RLT 400 to correspond to the current state of the SDN 100 and adjusts the routing of user packets 300 accordingly.

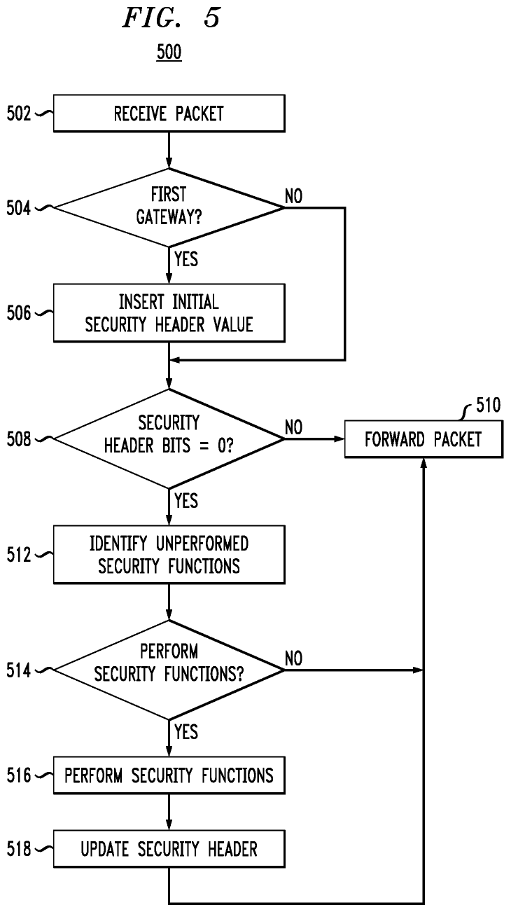

FIG. 5 is a flow diagram of the user-packet processing 500 performed by an NSG 154 as it relates to the performance of security operations. Those skilled in the art will understand that an NSG 154 may also perform other conventional processing on user packets 300 that is not represented in FIG. 5. The processing 500 of FIG. 5 begins, in step 502, with the NSG 154 receiving a user packet 300.

In step 504, the NSG 154 determines whether it is the first gateway in the SDN 100 to have received this user packet. In some implementations, based on the NSG port of FIG. 2 at which the user packet is received, each NSG 154 is able to determine whether it receives a user packet (i) directly from a UE (for an upstream user packet) or from the external network (for a downstream user packet), in which case, the NSG 154 will be the first gateway to receive the packet or (ii) from another NSG 154, in which case, the current NSG 154 will be a so-called “subsequent gateway”, that is, a downstream gateway that is not the first gateway to receive the packet. In other implementations, the security header 304 has an additional, flag bit (not shown in FIG. 3) that indicates whether the NSG 154 is the first gateway or a subsequent gateway to receive that packet. In these implementations, when the UE or the external network generates a user packet 300, the security-header flag bit will be set to, e.g., 0. The first NSG 154 to receive that packet will (a) inspect the flag bit value to determine that it is the first gateway to receive that packet and (b) flip that flag bit to indicate to any subsequent NSGs 154 that they are not the first gateway.

In either implementation, if the NSG 154 determines in step 504 that it is not the first gateway to receive the packet, then processing continues to step 508. If, however, the NSG 154 determines in step 504 that it is the first gateway to receive the packet, then, in step 506, the NSG 154 inserts its local copy of the initial security header value into the packet's security header 304.

In step 508, the NSG 154 determines if any of the bits in the packet's security header 304 have a value of 0 indicating that the corresponding security operation(s) has/have not yet been performed for the packet. If the NSG 154 determines in step 508 that none of the security header bits have a value of 0 (i.e., all four bits are set to one), then the NSG 154 determines that no more security operations need to be performed for the packet and processing proceeds to step 510, where the packet is forwarded, according to the routing policy for the packet, (i) to the next downstream NSG 154 if the current NSG 154 is not the last gateway for the packet or (ii) to either a UE or the external network if the current NSG 154 is the last gateway for the packet. If, however, the NSG 154 determines in step 508 that one or more of the security header bits have a value of 0, then, in step 512, the NSG 154 identifies the corresponding security operations that still need to be performed for the packet.

In step 514, the NSG 154 refers to its local copy of the RLT 400 to determine whether the NSG 154 is allowed to perform one or more of the needed security operations identified in step 512. If not, then processing proceeds to step 510 for forwarding. Otherwise, processing proceeds to step 516, where a security operation executor 160 in the NSG 154 performs the one or more needed security operations that the RLT 400 indicates are allowed to be performed by the NSG 154. In step 518, for each security operation that was performed by the NSG 154, the NSG 154 sets the corresponding bit in the packet's security header 304 to 1 to indicate to any subsequent NSGs 154 that the corresponding security operation has already been performed for that packet. Processing then continues to step 510 for forwarding.

The processing 500 of FIG. 5 ensures that each security operation that is selected to be performed on each user packet 300 is performed no more than once as the packet flows through the SDN 100. Furthermore, the NMS 110 ensures that the route selected for each packet 300 will eventually reach a set of NSGs 154 that are collectively enabled to perform all of the selected security operations.

The processing 500 of FIG. 5 has been described in the context of a single user packet 300 having a corresponding initial security header value and a corresponding RLT 400. Those skilled in the art will understand that, in some implementations, user packets 300 corresponding to different packet flows in the SDN 100 may have different corresponding initial security header values and/or different corresponding RLTs 400. As such, the sets of security operations may differ for different packet flows and/or the subsets of NSGs 154 that are enabled to perform those security operations may also differ for different packet flows.

FIG. 6 is a simplified hardware block diagram of an example node 600 that can be used to implement any of the nodes of FIG. 1, such as the network management system 110 and each NSG 154, as well as each user equipment and the external network that communicates via the SDN 100 of FIG. 1 . . . . As shown in FIG. 6, the node 600 includes (i) communication hardware (e.g., wireless, wireline, and/or optical transceivers (TRX)) 602 that supports communications with other nodes, (ii) a processor (e.g., CPU microprocessor) 604 that controls the operations of the node 600, and (iii) a memory (e.g., RAM, ROM) 606 that stores code executed by the processor 604 and/or data generated and/or received by the node 600.

In certain embodiments, the present disclosure is a network management system (NMS) for a software-defined network (SDN) having multiple network service gateways (NSGs), the NMS comprising at least one processor and at least one memory storing instructions that, upon being executed by the at least one processor, cause the NMS at least to (i) transmit, to the NSGs, an initial security header value for user packets, wherein the initial security header value indicates whether one or more security operations are to be performed for the user packets and (ii) transmit, to the NSGs, a mapping that identifies which NSGs are enabled to perform which security operations.

In at least some of the above embodiments, the NSGs are part of a cluster of NSGs.

In at least some of the above embodiments, the NMS is adapted to (i) receive resource metric telemetry data from the NSGs characterizing operations of the NSGs and (ii) generate the mapping based on the resource metric telemetry data.

In at least some of the above embodiments, the NMS is adapted to transmit, to the NSGs, at least two different instances of the initial security header value for user packets of at least two different packet flows in the SDN.

In at least some of the above embodiments, the NMS is adapted to transmit, to the NSGs, at least two different instances of the mapping for user packets of at least two different packet flows in the SDN.

In certain embodiments, the present disclosure is a network service gateway (NSG) for an SDN, the NSG comprising at least one processor and at least one memory storing instructions that, upon being executed by the at least one processor, cause the NSG at least to (i) receive an initial security header value for user packets, wherein the initial security header value indicates whether one or more security operations are to be performed for the user packets; (ii) receive a mapping that identifies which NSGs are enabled to perform which security operations; (iii) receive a user packet; (iv) determine whether the NSG is a first gateway to receive the user packet; (v) if the NSG determines that the NSG is the first gateway to receive the user packet, then store the initial security header value into a security header of the user packet; (vi) determine whether the security header indicates that one or more security operations need to be performed for the user packet; (vii) if the NSG determines that the security header indicates that one or more security operations need to be performed for the user packet, then determine whether the NSG is enabled to perform any of the one or more security operations that need to be performed for the user packet; and (viii) if the NSG determines that the NSG is enabled to perform one or more of the security operations that need to be performed for the user packet, then perform the one or more security operations and update the security header to indicate that the one or more security operations have been performed.

In at least some of the above embodiments, the security header comprises a different bit for each different security operation.

In at least some of the above embodiments, the NSG is adapted to receive the initial security header value and the mapping from an NMS of the network.

In at least some of the above embodiments, the NSG is adapted to transmit, to an NMS of the network, resource metric telemetry data characterizing operations of the NSG.

In certain embodiments, the present disclosure is an apparatus for communicating via an SDN, the apparatus comprising at least one processor and at least one memory storing instructions that, upon being executed by the at least one processor, cause the apparatus at least to (i) generate a user packet having a security header, wherein two or more bits of the security header correspond respectively to two or more different security operations that can be performed for the user packet; and (ii) transmit the user packet to an NSG of the SDN.

In at least some of the above embodiments, the apparatus is user equipment (UE) or an external network.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard, and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1-only A; 2-only B; 3-both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A network management system (NMS) for a software-defined network (SDN) having multiple network service gateways (NSGs), the NMS comprising:
at least one processor; and
at least one memory storing instructions that, upon being executed by the at least one processor, cause the NMS at least to:
transmit, to the NSGs, an initial security header value for user packets, wherein the initial security header value indicates whether one or more security operations are to be performed for the user packets; and
transmit, to the NSGs, a mapping that identifies which NSGs are enabled to perform which security operations.

2. The NMS of claim 1, wherein the NSGs are part of a cluster of NSGs.

3. The NMS of claim 1, wherein the NMS is adapted to:
receive resource metric telemetry data from the NSGs characterizing operations of the NSGs; and
generate the mapping based on the resource metric telemetry data.

4. The NMS of claim 1, wherein the NMS is adapted to transmit, to the NSGs, at least two different instances of the initial security header value for user packets of at least two different packet flows in the SDN.

5. The NMS of claim 1, wherein the NMS is adapted to transmit, to the NSGs, at least two different instances of the mapping for user packets of at least two different packet flows in the SDN.

6. A method for an NMS of an SDN, the method comprising the NMS:
transmitting, to the NSGs, an initial security header value for user packets, wherein the initial security header value indicates whether one or more security operations are to be performed for the user packets; and
transmitting, to the NSGs, a mapping that identifies which NSGs are enabled to perform which security operations.

7. The method of claim 6, wherein the NSGs are part of a cluster of NSGs.

8. The method of claim 6, further comprising the NMS:
receiving resource metric telemetry data from the NSGs characterizing operations of the NSGs; and
generating the mapping based on the resource metric telemetry data.

9. The method of claim 6, wherein the NMS transmits, to the NSGs, at least two different instances of the initial security header value for user packets of at least two different packet flows in the SDN.

10. The method of claim 6, wherein the NMS transmits, to the NSGs, at least two different instances of the mapping for user packets of at least two different packet flows in the SDN.

11. A network service gateway (NSG) for an SDN, the NSG comprising:
at least one processor; and
at least one memory storing instructions that, upon being executed by the at least one processor, cause the NSG at least to:
receive an initial security header value for user packets, wherein the initial security header value indicates whether one or more security operations are to be performed for the user packets;
receive a mapping that identifies which NSGs are enabled to perform which security operations;
receive a user packet;
determine whether the NSG is a first gateway to receive the user packet;
if the NSG determines that the NSG is the first gateway to receive the user packet, then store the initial security header value into a security header of the user packet;
determine whether the security header indicates that one or more security operations need to be performed for the user packet;
if the NSG determines that the security header indicates that one or more security operations need to be performed for the user packet, then determine whether the NSG is enabled to perform any of the one or more security operations that need to be performed for the user packet; and
if the NSG determines that the NSG is enabled to perform one or more of the security operations that need to be performed for the user packet, then perform the one or more security operations and update the security header to indicate that the one or more security operations have been performed.

12. The NSG of claim 11, wherein the security header comprises a different bit for each different security operation.

13. The NSG of claim 11, wherein the NSG is adapted to receive the initial security header value and the mapping from an NMS of the network.

14. The NSG of claim 11, wherein the NSG is adapted to transmit, to an NMS of the network, resource metric telemetry data characterizing operations of the NSG.

15. A method for an NSG of an SDN, the method comprising the NSG:
receiving an initial security header value for user packets, wherein the initial security header value indicates whether one or more security operations are to be performed for the user packets;
receiving a mapping that identifies which NSGs are enabled to perform which security operations;
receiving a user packet;
determining whether the NSG is a first gateway to receive the user packet;
if the NSG determines that the NSG is the first gateway to receive the user packet, then storing the initial security header value into a security header of the user packet;
determining whether the security header indicates that one or more security operations need to be performed for the user packet;
if the NSG determines that the security header indicates that one or more security operations need to be performed for the user packet, then determining whether the NSG is enabled to perform any of the one or more security operations that need to be performed for the user packet; and
if the NSG determines that the NSG is enabled to perform one or more of the security operations that need to be performed for the user packet, then performing the one or more security operations and updating the security header to indicate that the one or more security operations have been performed.

16. The method of claim 15, wherein security header comprises a different bit for each different security operation.

17. The method of claim 15, wherein the NSG receives the initial security header value and the mapping from an NMS of the network.

18. The method of claim 15, wherein the NSG transmits, to an NMS of the network, resource metric telemetry data characterizing operations of the NSG.

19. An apparatus for communicating via an SDN, the apparatus comprising:
at least one processor; and
at least one memory storing instructions that, upon being executed by the at least one processor, cause the apparatus at least to:
generate a user packet having a security header, wherein two or more bits of the security header correspond respectively to two or more different security operations that can be performed for the user packet; and
transmit the user packet to an NSG of the SDN.

20. The apparatus of claim 19, wherein the apparatus is user equipment (UE) or an external network.

21. A method for an apparatus to communicate via an SDN, the method comprising the apparatus:
generating a user packet having a security header, wherein two or more bits of the security header correspond respectively to two or more different security operations that can be performed for the user packet; and transmitting the user packet to an NSG of the SDN.

22. The method of claim 21, wherein the apparatus is a UE or an external network.
